(19) United States
(12) Patent Application Publication
(10) Pub. No.: US 2010/0290099 A1
(43) Pub. Date: Nov. 18, 2010

(54) Method and Apparatus for Creating and Displaying a Radially Multiplexed Hologram

(76) Inventors: Joyce A. Padiyar, Escondido, CA (US); Dinesh D. Padiyar, Escondido, CA (US)

Correspondence Address: MANDOUR & ASSOCIATES, APC, 16870 W. BERNARDO DRIVE, SUITE 400, San Diego, CA, 92127, US

(21) Appl. No.: 12/781,731

(22) Filed: May 17, 2010

Related U.S. Application Data
(60) Provisional application No. 61/216,447, filed on May 18, 2009.

(51) Int. Cl. G03H 1/30; G03H 1/22

(52) U.S. Cl. 359/26; 359/25

(57) ABSTRACT

A method and apparatus for recording and displaying a radially multiplexed hologram is provided. A master hologram is recorded with individual views or frames, arranged in a specific radial pattern and in such a proportion that the convergence of the individually recorded views are simultaneously combined and recorded onto a second hologram. When the second hologram is illuminated by a correctly designed light source a free floating image projecting above the platform on which it was recorded is displayed. The rotating platform presents sequential views to a fixed viewer, creating a moving image.

### CLAIM OF PRIORITY

The present application for patent claims priority from U.S. Provisional Application No. 61/216,447, filed May 18, 2009, assigned to the assignee hereof and hereby expressly incorporated by reference herein.

### BACKGROUND OF THE INVENTION

The present invention pertains to a method and apparatus for creating and displaying a radially multiplexed hologram for full 360° viewing of an image as well as providing a moving image.

Holography is a technique that allows light scattered from an object to be recorded and later reconstructed so that the object appears to be in the same position relative to the recording medium as it was during the recording process. As the viewer's position changes, the image changes position and orientation exactly as if the object were still present, thus providing a three-dimensional image.

The technique of holography may also be used to store, retrieve and process information. Holographic data storage provides storage of information at high densities inside crystals or photopolymers. Three-dimensional storage utilizes the volume of the recording media to store data, not just the surface, enabling much greater storage than currently available with present storage devices.

Holograms are also widely used for security purposes because holograms are very difficult to forge as they are replicated from a master hologram. Some countries, such as Brazil, Great Britain, Canada, South Korea, and the European Union incorporate holograms into currency. Holograms are often found on credit and bankcards as well. Holographic scanners are also found in post offices, shipping companies, and automated conveyor systems to aid in determining the three-dimensional size of a package. These scanners may be used in conjunction with checkweighers to allow automated pre-packing of predetermined volumes, such as found in bulk shipping of goods.

Additionally, holograms have even been used to create unique works of art, with such noted artists as Salvador Dali employing holograms for artistic purposes. All of these uses have one common drawback, the created holograms have not allowed for a free standing full 360° viewing with moving images. The images in previous holograms have always been constrained to appear within enclosed boundaries.

There is a need in the art for a method and apparatus for creating and viewing free-standing holograms with a 360° viewing and moving images.

### SUMMARY OF THE INVENTION

An embodiment of the invention provides a method of recording a radially multiplexed hologram. The method includes the steps of recording a master hologram, where the individual frames comprising the desired object are arranged in a radial pattern in a specific proportion to foster convergence. A second hologram is next recorded. This second hologram is a convergence of the simultaneous recording and combining individual frames with the master hologram.

A further embodiment of the invention provides a method of recording a master hologram. The method begins with the display of an individual frame of a series of frames comprising the object to be holographically displayed. Each frame is individually recorded on the outer perimeter of a recording medium. The next frame in the sequence is then displayed and recorded, again on the outer perimeter of the recording medium. This continues until all frames in the sequence of frames have been displayed and recorded.

Yet a further embodiment of the present invention provides a method of displaying a radially multiplexed hologram. The method consists of loading a radially multiplexed hologram into a display device. The display device contains a light source to illuminate the radially multiplexed hologram as well as corrective optics. The radially multiplexed hologram is illuminated once loaded into the display device. If the radially multiplexed hologram contains a video sequence, a rotation stage is activated to display the moving animation sequence.

The present invention further provides an apparatus for displaying radially multiplexed holograms. The display device includes a receptacle for a holographic medium containing a hologram to be displayed. A light source coupled to a corrective optic in a specified geometry and proportion is also a part of the display device. The light source and coupled corrective optic are coupled to a power source. A rotation stage may also be included to display moving scenes.

A still further embodiment provides an apparatus for recording radially multiplexed holograms. The apparatus includes means for recording a master hologram, wherein individual frames are arranged in a radial pattern and in a specific proportion. In addition, the apparatus includes means for recording a second hologram, where the second hologram is a convergence of a simultaneous recording and combining individual frames with the master hologram to create a radially multiplexed hologram.

A further embodiment of the present invention provides an apparatus for recording a master hologram. The apparatus includes means for displaying an individual frame of a sequence of frames, means for recording the individual frame holographically on an outer perimeter of a recording medium, means for displaying a next frame in the sequence of frames, means for recording the next frame holographically on the outer perimeter of the recording medium, means for continuing to display and record until all frames in the sequence of frames have been displayed and recorded.

A still further embodiment of the present invention provides an apparatus for displaying a radially multiplexed hologram. The apparatus comprises: means for loading a radially multiplexed hologram onto a display device, the display device containing a light source and corrective optics; and means for activating the display device to illuminate the radially multiplexed hologram. The display device may also contain means for rotating the radially multiplexed hologram to display a moving scene.

Various aspects and embodiments of the invention are described in further detail below.

### BRIEF DESCRIPTION OF THE SEVERAL VIEWS OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1 illustrates a holographic recording process, according to an embodiment of the invention.

FIG. 2 illustrates a holographic reconstruction process, according to an embodiment of the invention.

FIG. 3 depicts a display unit, according to an embodiment of the invention.

FIG. 4 depicts the image capture process according to an embodiment of the invention.

FIG. 5 illustrates the hologram on the final disk with recorded segments, according to an embodiment of the invention.

FIG. 6 illustrates recording the hologram master, according to an embodiment of the invention.

FIG. 7 is a flowchart illustrating the process of recording the hologram master, according to an embodiment of the invention.

FIG. 8 depicts the recording the final hologram, according to an embodiment of the invention.

FIG. 9 is a flowchart illustrating the process of recording the final hologram, according to an embodiment of the invention.

FIG. 10 depicts the display unit, according to an embodiment of the invention.

FIG. 11 is a flowchart illustrating the process of displaying the hologram, according to an embodiment of the invention.

FIG. 12 depicts an automated control system for creating master disks, according to an embodiment of the invention.

### DETAILED DESCRIPTION OF THE INVENTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Holography was discovered in 1947 by Hungarian physicist Dennis Gabor while researching ways to improve electron microscopes. Gabor's original technique is still used in electron microscopy, however, holography advanced significantly after the development of the laser in 1960. The first holograms recorded three-dimensional objects. Advances in photochemical processing techniques led to the production of the first high quality display holograms.

Several types of hologram can be made. Transmission holograms are viewed by shining laser light through them and looking at the reconstructed image from the side of the hologram opposite the source. A refinement of this technique is the “rainbow transmission” hologram that allows illumination by white light or other monochromatic light sources. Rainbow holograms are commonly found on credit cards as a security feature as well as on product packaging. These holograms are formed as surface relief patterns in a plastic film and incorporate a reflective aluminum coating to serve as a light source “behind’ the image to reconstruct the image features.

Multicolor holograms are also possible. The reflection hologram, or Denisyuk hologram, produces multicolor images using a white light located on the same side of the hologram as the viewer.

Recent advances have included the production of low-cost solid-state lasers, such as those found in items like the low-cost DVD recorders and players. These inexpensive solid-state lasers can compete effectively with larger more expensive gas lasers that were formerly required to produce holograms. These inexpensive lasers have facilitated the development of additional uses for holograms, particularly for researchers with smaller budgets, artists, and hobbyists.

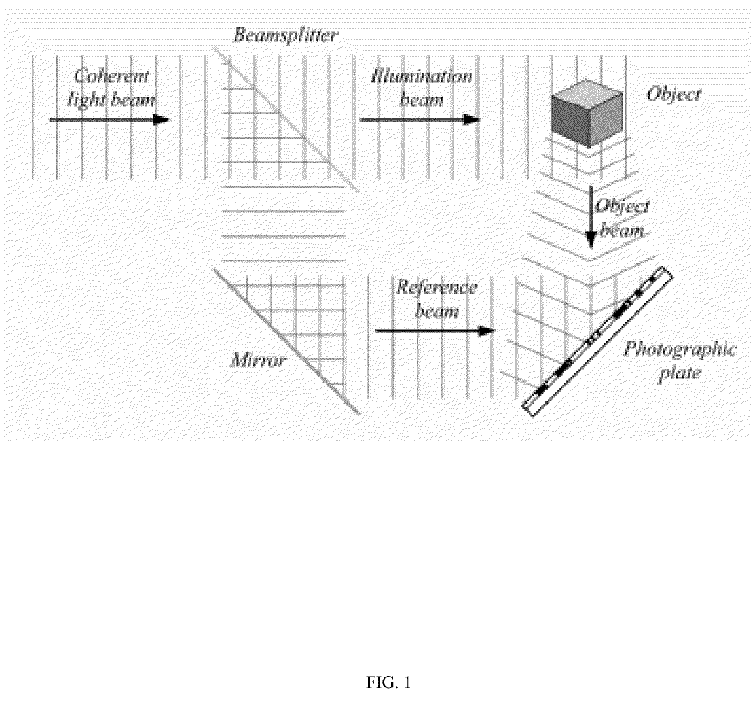

Holography may be similar to sound recording where the sound recorded is encoded so that it may later be reproduced. In holography, some of the light scattered from an object or group of objects falls on the recording medium. This is illustrated in FIG. 1. A second light beam, also known as the reference beam, also falls on the recording medium such that interference occurs between the two light beams. The resulting light field is an apparently random pattern of varying intensity, which is the hologram. If the hologram is illuminated by the original reference beam, a light field is diffracted by the reference beam, which is identical to the light field that was scattered by the object or group of objects. Someone looking into the hologram “sees” the objects even though the objects are no longer present. A variety of recoding materials may be used, including photographic film and digital recording mediums.

Interference occurs when one or more wavefronts are superimposed. Diffraction occurs whenever a wavefront encounters an object. Holography is a result of both interference and diffraction operating.

A diffraction grating is a structure with a repeating pattern. One example is a metal plate with slits cut at regular intervals. Light rays traveling through the metal plate are bent at an angle determined by the wavelength of the light, λ, and d, the distance between the slits. The angle is given by sin θ=λ/d.

Superimposing two plane waves originating from the same light source makes a simple hologram. One beam, the reference beam, strikes the photographic or recording medium normally, while the other beam, the object beam, strikes the recording medium at an angle, θ. The relative phase between the two beams varies across the recording medium according to the formula 2πy sin θ/λ, where y is the distance along the recording medium. The relative phase changes by 2π at intervals of d=λ/sin θ, so that the spacing of the interference fringes is given by d. Thus, the relative phase of the object and reference beam is encoded as the maxima and minima of the fringe pattern.

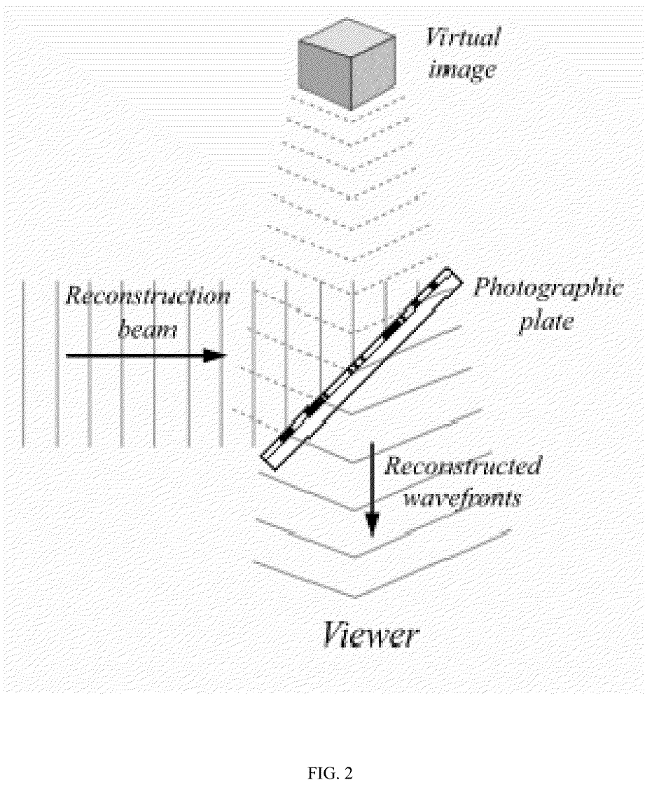

When the recording medium is developed or analyzed, the fringe pattern acts as a diffraction grating, and when the reference beam is incident upon the recording medium or photographic plate, it is partially diffracted into the same angle θ at which the original beam struck the photographic plate or recording medium. This results in a reconstruction of the object beam. The diffraction grating created by two interfering waves has reconstructed the object beam, forming a hologram. FIG. 2 illustrates the reconstruction process.

A more complicated hologram may be made using a point source of light as an object beam and a plane wave as the reference beam to illuminate a recording medium. In this case, the interference pattern is formed in curves of decreasing separation with increasing distance from the center.

In this example, the photographic plate or recording medium is processed to produce a complicated pattern, which may be considered to be a diffraction pattern of varying spacing. When the medium is illuminated only by the reference beam, it is diffracted by the grating into various angles that depend on the local spacing of the pattern on the medium. The net effect of this is to reconstruct the object beam, giving the appearance of light coming from a point source behind the medium, even when the light source has been removed. The light emerging from the medium is identical to the light that emerged from the point source formerly present. The observer “sees” a point light source regardless of whether that source is present. This type of hologram is effectively a concave lens, since it converts a plane wavefront into a divergent wavefront. It will increase the divergence of any wave that is incident on it in the same way a normal lens does. The focal length is the distance between the point source and the plate.

To record a hologram of a complex object, a laser beam is first split into two separate beams of light using a beam splitter. The beam splitter is typically a half-silvered glass or birefringent material. One beam illuminates the object, reflecting its image onto the recording medium as the beam is scattered. The second, reference beam, illuminates the recording medium directly.

According to diffraction theory, each point in the object acts as a point source of light. Each of these point sources interferes with the reference beam, producing an interference pattern. The resulting pattern is the sum of a large number (theoretically, an infinite number) of a point source+reference beam interference patterns.

The viewer perceives a wavefront identical to the scattered wavefront of the object illuminated by the reference beam, thus giving the appearance that the object is still present. This is known as a “virtual” image because it is generated without the object in place. The direction of the light source seen to be illuminating the virtual image is that of the original illuminating beam.

A light wave may be modeled by a complex number U that represents the electric or magnetic field of the light wave. The amplitude and phase of the light are represented by the absolute value and angle of the complex number. The object and reference waves at any point in the holographic system are given by U₀ and U_{R}. The combined beam is U₀+U_{R}. The energy of the combined beams is proportional to the square of the magnitude of the electric wave:

|U₀+U_{R}|²=U₀U_{R}+|U_{R}|²+|U₀|²+U*_{R}U₀

If a recording medium is exposed to two beams, and then developed, its transmittance, T, is proportional to the light energy that was incident on the medium, and is given by:

T=k[U₀U*_{R}+|U_{R}|²+U₀|²+U₀U_{R}]

where k is a constant. When the developed medium is illuminated by the reference beam, the light transmitted through the medium, U_{H} is

U_{H}=TU_{R}=k[U₀U*_{R+}|U_{R}|²+|U₀|²+U*₀U_{R}]U_{R}=k[U₀+|U_{R}|²U_{R}+|U₀|²U_{R}+U*₀U²_{R}]

It can be seen that U_{H} has four terms. The first term is kU₀, since U_{R}U*_{R} is equal to one, and this is the reconstructed object beam. The second term represents the reference beam whose amplitude has been modified by U_{R}². The third term also represents the reference beam that has had its amplitude modified by U₀²; this modification causes the reference beam to be diffracted around its central direction. The fourth term is known as the “conjugate object beam.” This beam had the reverse curvature to the object beam, and forms a real image of the object in the space beyond the holographic plate.

In appearance a holographic recording appears as a random speckle pattern with random variations in intensity. It is only when the hologram is illuminated by a laser beam that a viewer sees the object used in the creation of the hologram because the light is diffracted by the hologram to reconstruct the light which was scattered from the object.

When viewing a scene, each eye captures a portion of the light scattered from the scene. The lens of each eye forms an image of the scene on the viewer's retina, in which light from each angular position is focused to a specific angular positioning the image plane. Because the hologram reconstructs the whole of the scattered light field that was incident on the hologram, the viewer sees the same image regardless of whether it was derived from the light field scattered from the object, or the reconstructed light field produced by the hologram, and is unable to ascertain whether he or she is looking at the real or the virtual object. If the viewer moves about, the object appears to move in the same way, regardless of whether the view is of the original or the reconstructed object. If several objects comprise the scene, they exhibit parallax. Viewers using stereoscopic vision (both eyes), receive depth information when viewing the hologram exactly the same way as when viewing the real scene.

It is apparent that a hologram is not merely a three dimensional photograph. A photograph records an image from a single viewpoint, defined by the position of the camera lens at the moment the photograph is taken. The hologram is not an image; rather, it is an encoding system that enables the scattered light field to be reconstructed. Images can be formed from any point in the reconstructed hologram, either with a camera or an eye.

Since each point in the hologram contains light from the original scene, in principle, the whole scene could be reconstructed from an arbitrarily small portion of the hologram. The hologram may be broken into small pieces and the entire object may still be seen from each small piece. The hologram may be imagined as a “window” on the object, with each small piece of the hologram forming a part of the window, from which the object can still be viewed, even if the window is partially blocked. Despite this, as the size of the hologram is reduced, the image does lose resolution. This is a result of diffraction and arises in the same manner as the resolution of an imaging system is ultimately limited by diffraction where the resolution becomes coarser as the lens or lens aperture diameter decreases.

To produce a hologram, both the object and reference beams must be able to produce a stable interference pattern during the time of recording the holographic image is made. In order to do this, both beams must have the same frequency and relative phase during the recording, or in other words, they must be mutually coherent. Many laser beams meet this condition and may be used.

Furthermore, the recording medium used to record the fringe pattern must be able to resolve the fringe patterns. The spacing of the fringes depends upon the angle between the object and the reference beam. As an example, if this angle is 45°, and the wavelength of light is 0.5 μm, the fringe spacing is approximately 0.7 μm or 1300 lines/mm. A working hologram may still be obtained even if all of the fringes are not resolved, but the resolution of the image may be reduced.

Mechanical stability is also important in forming a hologram. Any relative phase change between the object and reference beams due to vibration or air movement causes the fringes on the recording medium to move, and if the phase change is greater than π, the fringe pattern averages out, and no holographic recording is produced. Recording times may be on the order of several seconds or more, and given that a phase change of π is equivalent to a movement of λ/2, this imposes a stringent stability requirement.

The coherence length of the light determines the maximum depth that may be recorded holographically in the desired scene. A suitable laser typically has a coherence length of several meters, ample for a deep hologram. Laser pointers have even been used to create holograms. Size of the hologram is not restricted by the coherence length of the laser pointer used, but rather, by its low power, typically below 5 mW.

The objects forming the scene should have optically rough surfaces so that light is scattered over a wide range of angles. A specularly reflecting (shiny) surface reflects light in only one direction at each point on its surface, causing most of the light not to be incident on the recording medium. Light scattered from objects with rough surfaces forms an objective speckle pattern having random amplitude and phase.

Normally the reference beam is not a plane wavefront, instead, it is usually a divergent wavefront formed by placing a convex lens in the path of the laser beam.

In order to reconstruct an object exactly from a transmission hologram, the reference beam must have the same wavelength and curvature, and must illuminate the hologram at the same angle as the original reference beam (that is, only the phase may be changed). Straying from any of these conditions produces a distorted reconstruction. The reconstructed hologram may be enlarged if the light used in the reconstruction has a higher wavelength. An exact reconstruction is achieved where the holographically reconstructed wavefront interferes with the live wavefront, to map out any displacement of the live object, and also gives a null fringe if the object has not moved.

In addition to the above requirements, the recording medium must convert the interference pattern into an optical element that modifies the amplitude or the phase of a light beam incident upon it. These are known as amplitude and phase holograms. In amplitude holograms the modulation is in the varying absorption of light by the hologram, similar to the action of a developed photographic emulsion, which varies in absorptivity depending on the intensity of the light which illuminated it. In phase holograms, the optical distance (the refractive index, or in some cases, thickness) in the material is modulated.

The present invention is directed toward recording a hologram of an object or of a three dimensional animation onto a disk and placing that disk in a unit that displays the hologram as a three dimensional image or animation in the free space above the disk. The image from the disk may be viewed at any angle around the disk. Additionally, the unit may also rotate the disk, so that a viewer at a specific position received the impression of a real object floating above the disk, or of an animation playing out in three dimensions above the disk.

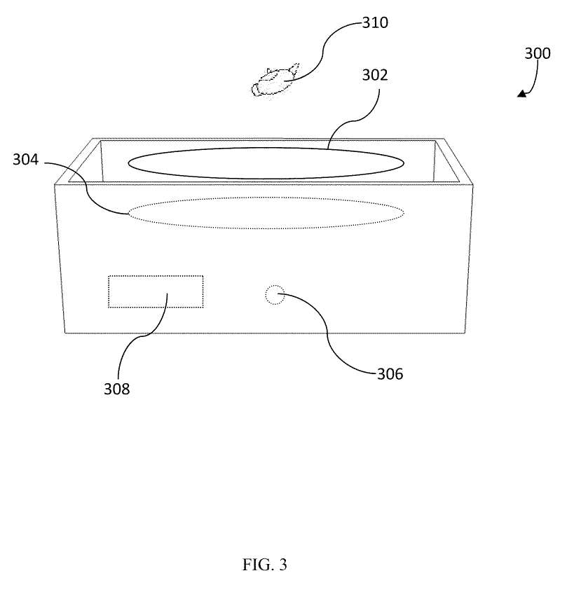

FIG. 3 illustrates a display unit for the three-dimensional or animation viewer. The display unit 300 includes the hologram disk 302, a light source, such as an LED 306. The light source may be powered by a wall socket or by a battery. Beam shaping optic 304 orients the light from the LED to correctly display the image 310. A depression on the top surface of display unit 300 facilitates correct disk placement. Motor 308 provides rotational movement to the display unit, rotating the hologram disk 302. A sound chip or board may also be incorporated into display unit 300 to provide for sounds accompanying the display. A power switch is also provided.

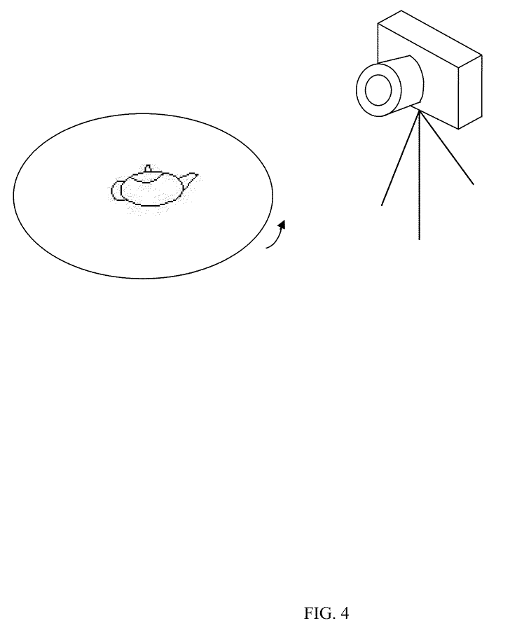

The images may be created using as sources images obtained from photography, video images, or computer graphics. For photographic images, the set up of FIG. 4 is used. A real object is placed on a turntable or other device providing rotational movement. A camera is placed above and to one side of the object. The object is then photographed and the turntable is rotated through a small angle, such as one degree, and then photographed again. This process is repeated until the object has been rotated through 360 degrees. The individual photographs may then be stored in a computer.

A video sequence may also be used as an image source. Standard sources of video including video cameras, cell phones, or digital cameras with video capability may be used. The video sequence is first captured and then passed to a software program that splits the video sequence into a series of still frames. The still frames are then stored in a computer.

Computer graphics packages with three-dimensional capability may also be used to generate a three dimensional computer graphic image. A virtual camera captures two-dimensional views of the three dimensional object by rotating around the object in virtual space. This generates a series of still frames, which are stored in a computer.

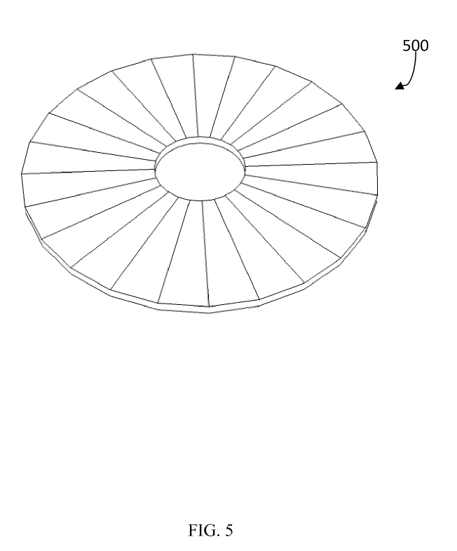

FIG. 5 illustrates the master disk containing the hologram. The hologram on the final disk is recorded in two stages. Initially, the hologram is encoded as a series of strips arranged in a radial manner around the outer portion of a large “master” disk. The “master disk” is approximately three times greater than or equal to three times the diameter of the final disk. A second hologram is then created and placed on the final disk. The final disk is placed in the display unit to display the hologram.

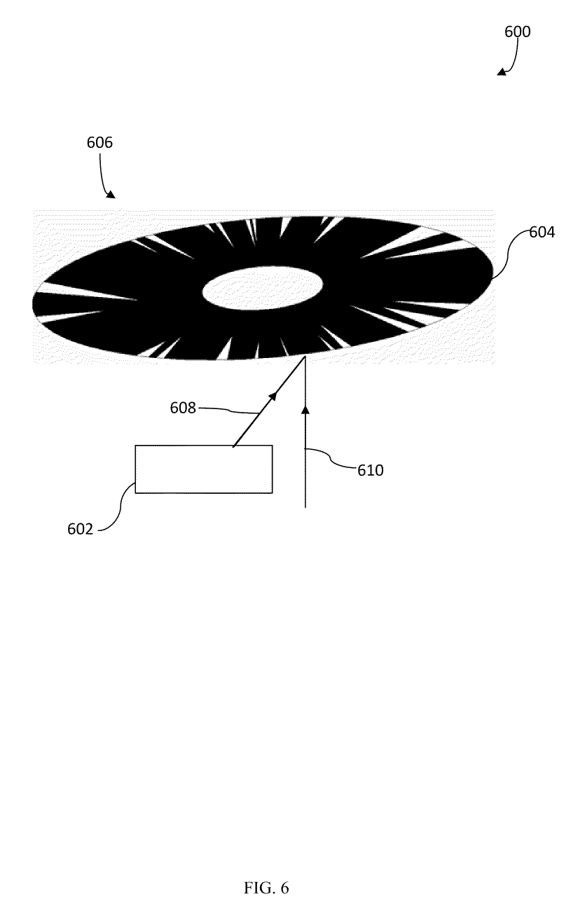

FIG. 6 illustrates recording the hologram master, 600. Individually pre-recorded “frames” or “views” of an object are sequentially displayed 602 and recorded holographically in sections 604 around the outer one-third perimeter of the master hologram disk 606. One frame is presented at a time, illuminated with laser light 608, recorded by means of a laser “reference” 610. The master disk 606 is then rotated into position for the next frame. This continues until the full 360-degree view has been recorded. The hologram is then developed and becomes the master hologram.

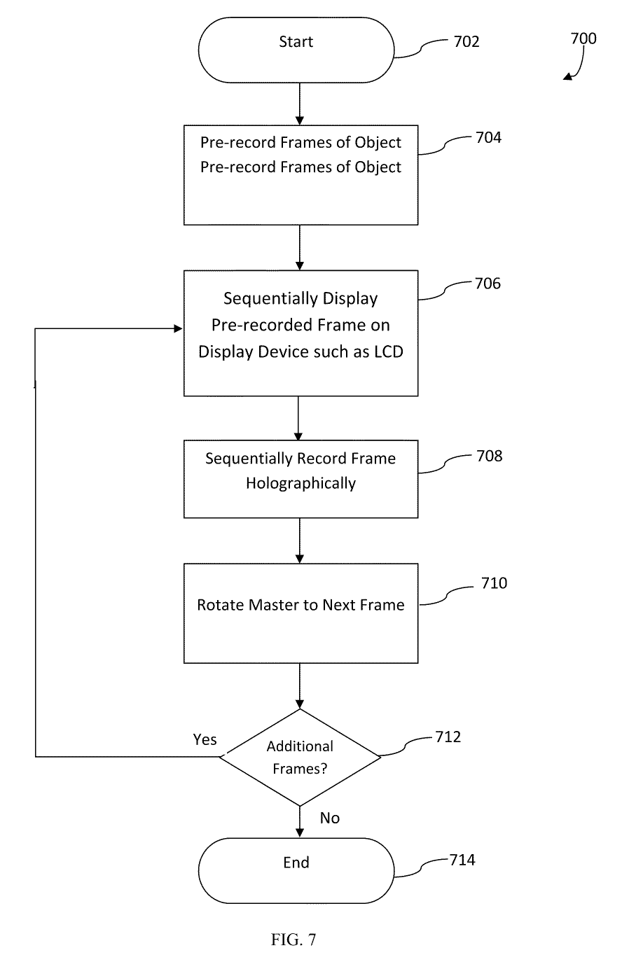

FIG. 7 is a flowchart describing the steps of the process of recording the hologram master, 700. The process begins at the start, 702. Pre-recorded frames of an object are collected in step 704. The image display device is altered to display sequentially the pre-recorded frame in step 706. The frame is recorded in step 708. After recording the displayed frame, the unit is rotated one increment in step 710. A check is made at step 712 to determine if additional frames remain to be recorded. If so, the process returns to step 706 and an additional frame is recorded and the process continues. If there are no additional frames to record, the process ends at step 714.

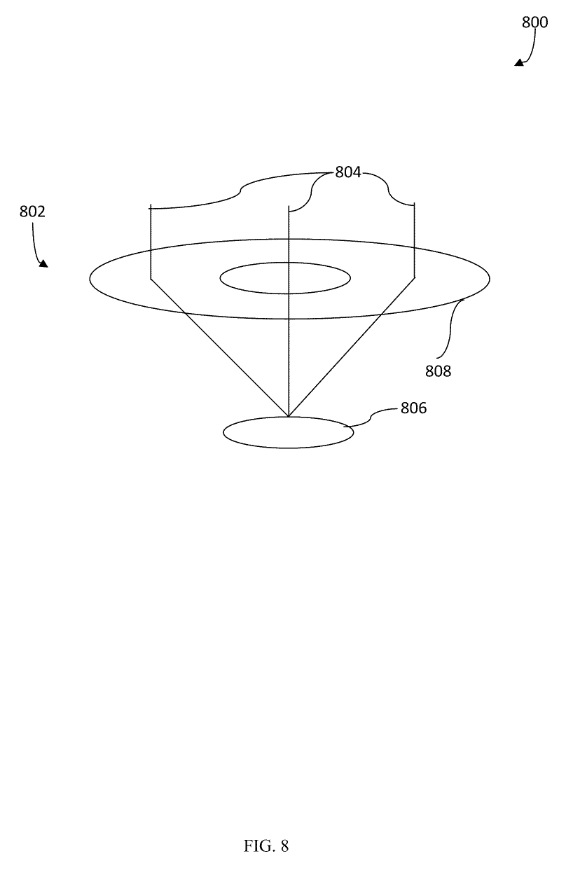

FIG. 8 illustrates the process of recording the final hologram. The FIG. 800, illustrates the master hologram 802 illuminated by a large reference laser beam 804. This beam passes through the clear center and impinges on the final hologram 806 and simultaneously diverts the full set of recorded frames from the outer ring inward 808 also onto the final hologram.

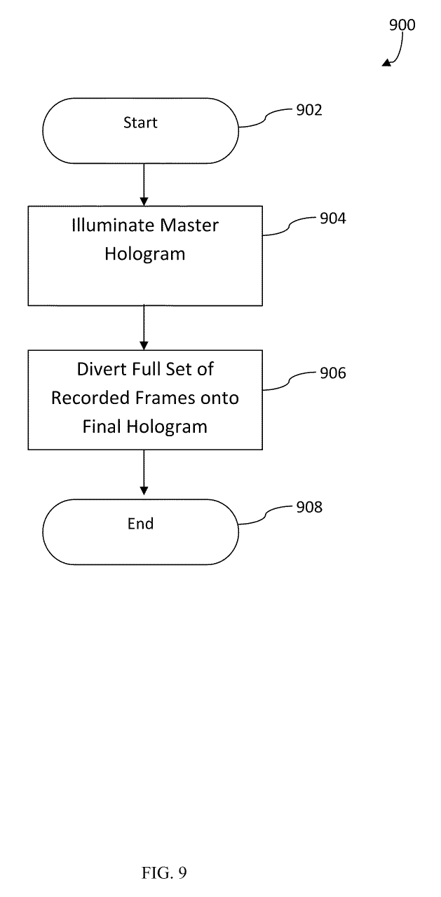

FIG. 9 is a flowchart of this process. The process 900, begins at start 902. The master hologram is illuminated at step 904. Once illuminated, the beam passes through the clear center and impinging on the final hologram, diverts the full set of recorded images onto the final hologram in step 906. Once this occurs, the process ends at step 908.

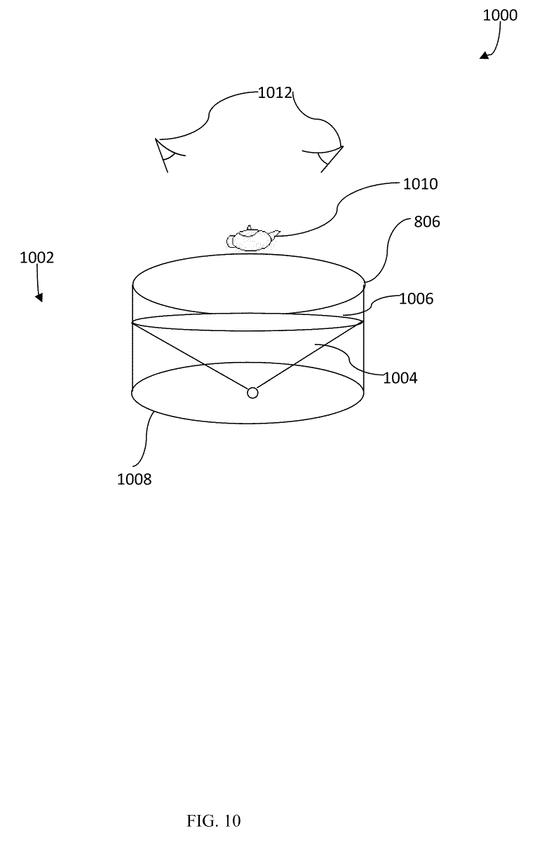

With the completion of the above steps, the hologram is ready for display on the display unit. FIG. 10 depicts the display process. The final hologram 806 is placed onto the recess at the top of the display unit 1002. Display unit 1002 contains a light source 1004 and corrective optic 1006, and if a moving scene is desired, a rotation stage 1008. The display unit 1002 contains the correct geometry and proportion to properly illuminate the hologram and cause it to appear to float in space 1010. The hologram is viewable 360 degrees 1012 around display unit 1002.

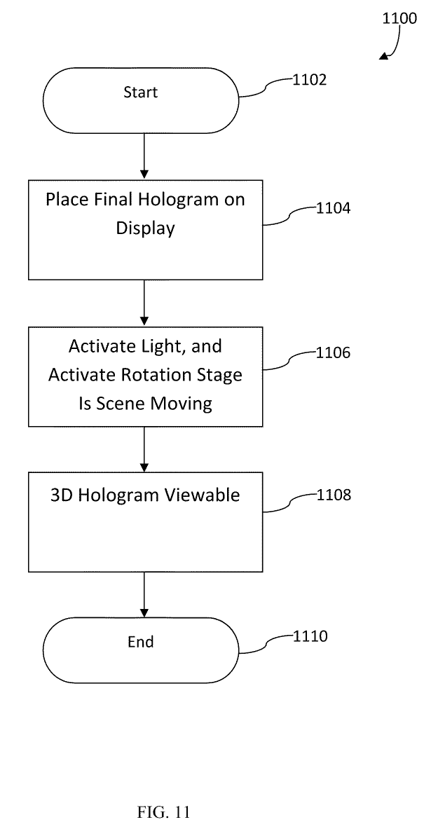

FIG. 11 provides a flowchart of the display process 1100. The process begins at start 1102. The user places the final hologram on the display unit in step 1104. The light is activated and if a moving scene is desired, the rotation stage is activated in step 1106. This causes the hologram to appear above the display unit in step 1108. The process ends at step 1110.

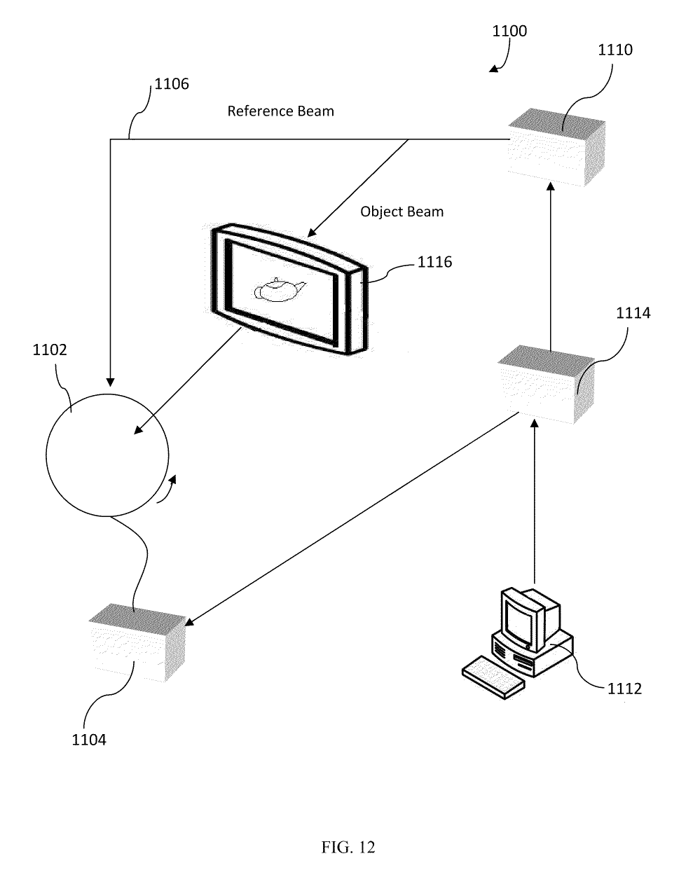

A further embodiment provides means and method to record the master hologram disks. FIG. 12 depicts the set up to record master hologram disks. A large glass disk coated with photosensitive emulsion capable of recording a hologram (the “master” hologram) 1102 is placed in a ring. An electronic control box containing a stepper motor driver 1104 and timing circuits is attached to the ring, allowing the ring to turn through angles of one degree or greater. The electronic components also control a shutter 1110 that opens and closes at fixed intervals. These fixed intervals may be set by the operator. An LCD device, or equivalent device capable of displaying a two dimensional image 1116 is connected to the computer 1112, such that any image displayed on the computer monitor 1112 is also displayed on the LCD 1116. The computer 1112 also contains the timing software. A laser beam is split by an optical beam splitter to produce a reference beam 1106 and an object beam 1108. One portion of the laser beam impinges on the master hologram and another portion is used to back light LCD 1116.

The system is then configured so that the shutter 1110, controlled by the electronic controller box 1114, opens for a pre-determined period of time, exposing the master hologram to a variety of laser light beams. At the same time, software in computer 1112 displays one of a set of images captured or generated as described above, on its monitor and also on LCD 1116.

The radial image line is now recorded. After the pre-determined time has elapsed, electronic control box 1114 turns off the shutter 1110, effectively shutting off the laser. A signal is then sent by electronic control box 1114 directing the stepper motor 1104 controller to turn the ring a pre-determined amount, usually one degree. After a brief pause, the computer 1112 displays the next image in the series and the entire sequence repeats. In this manner, at the end of the complete sequence up to 360 radial lines are exposed with a minimum width of one degree. This completes the first of two stages.

In the next stage the master hologram is illuminated by a laser beam. This generates all of the images from all of the slices simultaneously and focuses it in space. A second smaller disk, known as the final disk, is then exposed holographically to all the images from the series simultaneously. It is this final disk that is placed on the display unit. When this final disk is placed on the display unit and illuminated all the images in the series appear and are seen in three dimensions around the unit. If an animation was chosen, the animation is displayed.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of recording a radially multiplexed hologram, comprising:
recording a master hologram, wherein individual frames are arranged in a radial pattern and in a specific proportion; and
recording a second hologram, wherein the second hologram is a convergence of a simultaneous recording and combining individual frames with the master hologram.

2. The method of claim 1, wherein the individual frames are photographs.

3. The method of claim 1, wherein the individual frames are video frames forming an animation sequence.

4. The method of claim 1, wherein the individual frames are computer graphic images.

5. A method of recording a master hologram, comprising:
displaying an individual frame of a sequence of frames;
recording the individual frame holographically on an outer perimeter of a recording medium;
displaying a next frame in the sequence of frames;
recording the next frame in the sequence of frames holographically on the outer perimeter of the recording medium; and
continuing until all frames in the sequence of frames have been displayed and recorded.

6. The method of claim 5, wherein the individual frames are photographs.

7. The method of claim 5, wherein the individual frames are video frames forming an animation sequence, the sequence divided into individual frames.

8. The method of claim 5, wherein the individual frames are computer graphic images.

9. A method of displaying a radially multiplexed hologram, comprising:
loading a radially multiplexed hologram medium onto a display device, wherein the display device contains a light source and corrective optics; and
activating the display device to illuminate the radially multiplexed hologram.

10. The method of claim 9, further comprising activating a rotation stage in the display unit to display a moving scene.

11. An apparatus for displaying radially multiplexed holograms, comprising:
a receptacle for a holographic medium;
a light source coupled to a corrective optic in a specified geometry and proportion, coupled to a power source, and located beneath the holographic medium.

12. The apparatus of claim 11, further comprising a rotation stage.

13. An apparatus for recording radially multiplexed holograms, comprising:
means for recording a master hologram, wherein individual frames are arranged in a radial pattern and in a specific proportion; and
means for recording a second hologram, wherein the second hologram is a convergence of a simultaneous recording and combining individual frames with the master hologram.

14. An apparatus for recording a master hologram, comprising:
means for displaying an individual frame of a sequence of frames;
means for recording the individual frame holographically on an outer perimeter of a recording medium;
means for displaying a next frame in the sequence of frames;
means for recording the next frame in the sequence of frames holographically on the outer perimeter of the recording medium; and
means for continuing until all frames in the sequence of frames have been displayed and recorded.

15. An apparatus for displaying a radially multiplexed hologram, comprising:
means for loading a radially multiplexed hologram medium onto a display device, wherein the display device contains a light source and corrective optics; and
means for activating the display device to illuminate the radially multiplexed hologram.

16. The apparatus of claim 15, further comprising:
means for rotating an illuminated radially multiplexed hologram.
